(19) United States
(12) Patent Application Publication
(10) Pub. No.: US 2012/0195723 A1
(43) Pub. Date: Aug. 2, 2012

(54) Mobile Fully Automated Dirty Material Recovery Facility

(76) Inventor: Lina-Marie H. Mayla, Willowdale (CA)

(21) Appl. No.: 13/360,158

(22) Filed: Jan. 27, 2012

Related U.S. Application Data
(60) Provisional application No. 61/457,195, filed on Jan. 27, 2011.

(51) Int. Cl. B60P 1/36

(52) U.S. Cl. 414/502

(57) ABSTRACT

A mobile material recovery facility having a cabin, a trailer having an opening and an interior space, the interior space includes a main conveyor belt having a first end and a second end, wherein the first end is proximate to the opening, and a plurality of screens are positioned along the main conveyor belt, each screen having an associated second conveyor belt. A plurality of bunker containers are positioned on an outside of the trailer, each of the containers being in communication with an associated one of the second belts positioned in the interior space.

### RELATED APPLICATION

The application claims the benefit of 35 USC 119(e) to U.S. Provisional Application Ser. No. 61/457195 filed 27 Jan. 2011 (27 Jan. 2011).

### SCOPE OF THE INVENTION

The present invention relates to a mobile material recovery facility (hereafter “MRF”). More particularly, the present invention relates to a fully automated MRF vehicle and process to capture and sort food and beverage waste material removed from among other establishments, aircrafts and/or airport terminals.

### BACKGROUND OF THE INVENTION

As an example of the application, in preparing and cleaning aircrafts for departure after a flight, all consumer waste products, including recyclable materials, food waste and/or other garbage materials are co-mingled together in large disposable bags.

Traditionally, certain airport recycling facilities and infrastructures can not accept co-mingled (or single stream) waste and recyclable materials that have been collected from the aircrafts or airport terminals. Rather, airport facilities generally only accommodate previously separated recyclables, as for example aluminium cans, bottles and newspapers. Since the co-mingled recyclables are not accepted, in most cases, the co-mingled recyclables are diverted directly to landfills.

Accordingly, there is a need to improve the recycling capabilities of airport facilities and to improve the diversion rate of co-mingled recyclables away from landfill sites.

### SUMMARY OF THE INVENTION

The present invention seeks to provide a solution to the above-noted problems by providing an automated mobile MRF facility that allows for capturing and sorting of co-mingled recyclables and other waste materials. The automated mobile MRF in accordance with the present invention may be used in combination with existing recycling infrastructures at airports for example to increase rates of capture of recyclable materials.

In one aspect, the mobile MRF in accordance with the present invention will meet the needs of airports which do not currently have a system of capturing, sorting and transporting recyclable or compostable materials removed from aircrafts and/or airport terminals to the recycling facilities located near or at the airport. As each recycling infrastructure is different at each airport, the MRF in accordance with the present invention is operable to meet the requirements of existing airport recycling infrastructures in order to increase recycling rates of airlines and/or airport terminals as well as other establishments.

In a further aspect, the mobile MRF will be located at the airport facility to complement existing recycling infrastructure which is already installed at airports. The MRF in accordance with the present invention will be operable to capture and sort selected materials, typical of those which are removed from aircrafts and/or airport terminals or other establishments, including but not limited to glass, plastic containers, newspapers, aluminium cans, cardboard and food waste.

In a further aspect, the mobile MRF comprises a plurality of selected screens and optical sorter on a trailer that is operable to capture and sort the various co-mingled materials removed from the aircrafts.

In yet a further aspect of the invention, the MRF is operable to be leak proof, self-cleaning and self-sanitizing.

In yet a further aspect, the mobile MRF may be covered or uncovered on a trailer and may be provided with a detachable generator attached to a back end of the MRF to power and charge the operation of the MRF.

Once the MRF is ready to move, the generator may be detached from the back thereof so the MRF can be driven to the recycling site at or near the airport.

### BRIEF DESCRIPTION OF THE DRAWINGS

Reference may now be made to the following detailed description taken together with the accompanying drawing in which:

FIG. 1 shows an elevated side perspective view of a mobile MRF in accordance with the present invention.

### DETAILED DESCRIPTION OF THE DRAWINGS

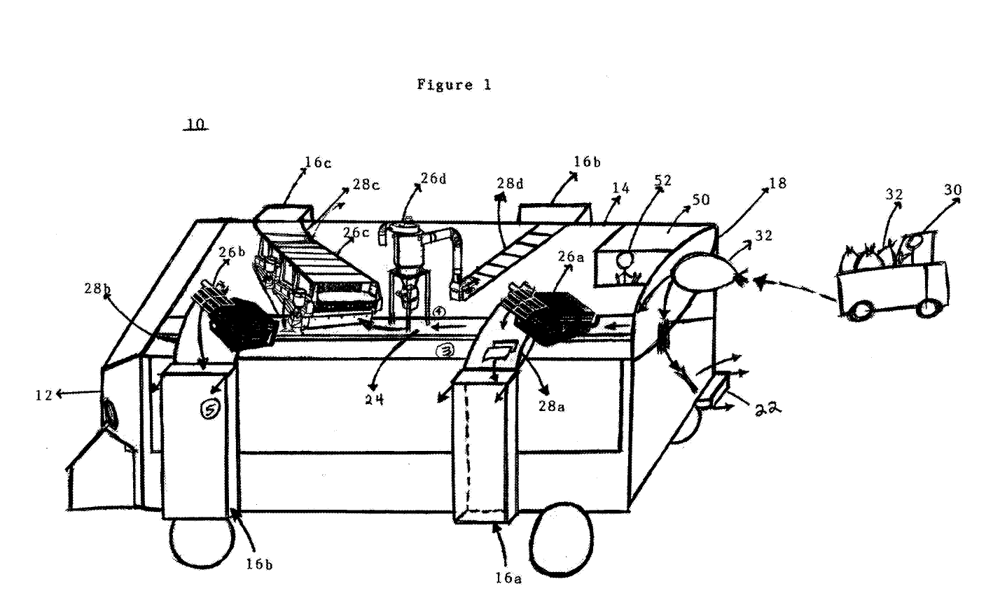

Reference may now be had to FIG. 1 which shows an elevated side perspective view of a mobile MRF 10 in accordance with the present invention. The mobile MRF 10 is provided as a motorized vehicle and includes a cabin 12 for a driver and is on top of a trailer that could be uncovered or covered. Located rearward of the cabin 12 there is provided a large cargo or trailer container 14 and a control box 50 for an operator 52 to control the operation of the MRF 10. On outer lateral sides of the cargo container 14 there is provided a plurality of detachable closed-lid or open-lid storage bunkers or bins 16a-16d which are in communication with an interior space of the cargo container 14.

On a back end of the cargo container 14 there is provided an opening 18 sized to receive a plurality of bags 32 which contain co-mingled waste and/or recyclable materials.

In the interior space of the cargo container 14 there is provided, proximate to the opening 18, an automated bag ripper 20 and a removable bag storage container 22. Running from the back end, proximate to the opening 18 of the cargo trailer 14, towards the cabin 12 there is provided a first main conveyor belt 24. Along the length of the main conveyor belt 24 there is provided a plurality of screens or filters 26a-26d for separating the co-mingled materials into their respective components including fibres, plastic containers, cartons or old corrugated cardboard, aluminium and/or ferrous metals. As the co-mingled material travel through each successive screen and the optical sorter, a selected component of recyclables are diverted from the main conveyor into their associated bunkers or bins 16a-16d via associated secondary conveyor belts 28a-28d.

A preferred operation of the mobile MRF will now be explained. A waste truck driver 30 transports bags 32 containing consumer waste collected from the establishments, aircrafts and flight kitchens and/or airport terminals to the mobile MRF 10. The bags 32 are collected and transported using currently used carts/trucks as this task is already performed at the airport, once an aircraft is cleaned or at any other establishment. The bags 32 are placed into the cargo container 14 through the opening 18. The opening 18 is sized to ensure that the bags 32 are captured by the MRF 10 appropriately.

The automated bag ripper 20 then rips the bags 32 open and the co-mingled materials within the bags 32 fall onto the main conveyor belt 24. The bags 32 that go through the bag ripper 20 are removed to the bag storage container 22 so that they may be disposed of at a later time.

The mobile MRF operator 52 operates the control box 50 and controls the operation of the MRF 10 using a touch screen for the optical sorting of plastics and for the operation of the screens that sort paper, metals, aluminium and residue/waste. The co-mingled materials travel on the main conveyor belt 24 and pass through successive screens 26a-26d where the co-mingled materials are sorted into their respective components. 26a and 26b respectively sort newspapers and containers, 26c sorts cardboard and 26d sorts glass if applicable. In the illustrated preferred embodiment shown, the co-mingled materials first pass through a paper screen 28a where for example newspapers will be diverted away from the main conveyor onto the secondary conveyor 28a and into the storage bunker or bin 16a. The fibres or papers would go through the first screens followed by the sorting of plastics performed by the optical sorting-not shown in the FIGURE of the mobile MRF 10.

Once the bunker 16a is filled, the bunker or bin 16a may be removed and replaced by an empty bunker or bin. The full bunker 16a may then be taken to the existing bins or compactors at the airport facility where the paper materials can be processed as per normal practice as a single stream of paper.

The remaining co-mingled material continues along the main conveyor belt 24 and passes through the remaining screens 26b-26d, as for example a cardboard screen, a plastic screen or optical sorter and food waste screen and are diverted into their associated bunkers, via their associated secondary belts 28b-28d. Once the associated bunkers are filled, they may be removed and transported to the airport recycling facility or any other facility for transportation to a recycler.

Although this disclosure has described and illustrated certain preferred embodiments of the present invention, it is to be understood that the invention is not restricted to these particular embodiments. For example, the present invention is not limited in the number of screen which may be used. It is also to be understood that the screens provided are directed to sorting materials which typically are removed from aircrafts and/or airport terminals or in other establishments.

What is claimed is:

1. A mobile material recovery facility comprising:
a cabin;
a trailer having an opening and an interior space, the interior space comprising a main conveyor belt having a first end and a second end, wherein the first end is proximate to the opening, and a plurality of screens positioned along the main conveyor belt, each screen having an associated second conveyor belt; and
a plurality of bunker containers positioned on an outside of the trailer, each of said containers being in communication with an associated one of the second belts positioned in the interior space.
